(19) United States
(12) Patent Application Publication
(10) Pub. No.: US 2025/0321803 A1
(43) Pub. Date: Oct. 16, 2025

(54) PIPELINE BURSTING ACROSS COMPUTING SYSTEMS

(71) Applicant: INTERNATIONAL BUSINESS MACHINES CORPORATION, ARMONK, NY (US)

(72) Inventors: Maja Curic, Munich (DE); Sagar Tayal, Ambala City (IN); Alecio Pedro Delazari Binotto, Munich (DE); Fernando Luiz Koch, Palm Beach Gardens, FL (US)

(21) Appl. No.: 18/634,849

(22) Filed: Apr. 12, 2024

(51) Int. Cl. G06F 9/50; G06F 9/38

(52) U.S. Cl. CPC G06F 9/505; G06F 9/3867; G06F 9/5038

(57) ABSTRACT

Provided are a computer program product, system, and method for pipeline bursting across computing systems. The computing systems receive, from distributed controllers, information on processing performance and data processing tasks, for user equipment. Data processing usage at the computing systems is predicted from the received information. Pipeline creation rules are generated to allocate pipeline computing resources to the computing systems to optimize for the predicted data processing usage. Pipeline redistribution rules are generated to direct traffic for the user equipment to pipelines within the computing systems allocated according to the pipeline creation rules. The pipeline redistribution rules include a bursting pipeline redistribution rule indicating to distribute received data to pipelines in multiple computing systems to process. The pipeline creation rules and the pipeline redistribution rules, including bursting redistribution rules, are transmitted to the distributed controllers to implement the pipeline creation rules and the pipeline redistribution rules.

### BACKGROUND OF THE INVENTION

### 1. Field of the Invention

The present invention relates to a computer program product, system, and method for pipeline bursting across computing systems.

### 2. Description of the Related Art

Cellular service providers maintain cellular towers, also referred to as base stations, to provide cellular service to a region within signal proximity to the base station. The base stations produce data processing jobs from user equipment that is processed in multi-access edge computing (MEC) systems. The MEC systems provide computing and storage resources at the network's edge close to end-users to reduce processing latency.

### SUMMARY

Provided are a computer program product, system, and method for pipeline bursting across computing systems. The computing systems receive, from distributed controllers, information on processing performance and data processing tasks, for user equipment. Data processing usage at the computing systems is predicted from the received information. Pipeline creation rules are generated to allocate pipeline computing resources to the computing systems to optimize for the predicted data processing usage. Pipeline redistribution rules are generated to direct traffic for the user equipment to pipelines within the computing systems allocated according to the pipeline creation rules. The pipeline redistribution rules include a bursting pipeline redistribution rule indicating to distribute received data to pipelines in multiple computing systems to process. The pipeline creation rules and the pipeline redistribution rules, including bursting redistribution rules, are transmitted to the distributed controllers to implement the pipeline creation rules and the pipeline redistribution rules.

### BRIEF DESCRIPTION OF THE DRAWINGS

FIG. 1 illustrates an embodiment of a cellular network environment with edge systems in which embodiments are implemented.

FIG. 2 illustrates an embodiment of a distributed controller managing edge systems.

FIG. 3 illustrates an embodiment of a centralized controller managing distributed controllers.

FIG. 4 illustrates an embodiment of a pipeline creation rule.

FIG. 5 illustrates an embodiment of a pipeline redistribution rule.

FIG. 6 illustrates an embodiment of a task processing entry providing information on processing of a data processing task.

FIG. 7 illustrates an example of a data processing report providing information on performance of data processing.

FIG. 8 illustrates an example of a user activity profile report on user profiles for data being processed.

FIG. 9 illustrates an embodiment of operations at the central controller to generate pipeline creation rules and pipeline redistribution rules.

FIG. 10 illustrates an embodiment of operations for a distributed controller to process pipeline creation rules to configure pipelines in edge systems.

FIG. 11 illustrates an embodiment of operations to determine one or more pipelines in one or more edge systems to process a data processing job using pipeline redistribution rules.

FIG. 12 illustrates a computing environment in which the components of FIGS. 1, 2, and 3 may be implemented.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description herein provides examples of embodiments of the invention, and variations and substitutions may be made in other embodiments. Several examples will now be provided to further clarify various embodiments of the present disclosure:

Example 1: A computer-implemented method comprising receiving, from distributed controllers, information on processing performance and data processing tasks, for user equipment, at computing systems. Data processing usage at the computing systems is predicted from the received information. The method further comprises generating pipeline creation rules to allocate pipeline computing resources to the computing systems to optimize for the predicted data processing usage. The method further comprises generating pipeline redistribution rules to direct traffic for the user equipment to pipelines within the computing systems allocated according to the pipeline creation rules. The pipeline redistribution rules include a bursting pipeline redistribution rule indicating to distribute received data to pipelines in multiple computing systems to process. The method further comprises transmitting the pipeline creation rules and the pipeline redistribution rules, including bursting redistribution rules, to the distributed controllers to implement the pipeline creation rules and the pipeline redistribution rules. Thus, embodiments advantageously allow a centralized computer to optimally generate both pipeline creation and redistribution rules for all computing systems based on data processing usage at the computing systems. The centralized computer optimizes how pipelines are configured in the computing systems and how jobs are distributed based on predicted usage at the computing systems to allow for bursting of processing of a data processing job across computing systems to further reduce processing latency and optimize usage of pipeline resources across computing systems.

Example 2: The limitations of any of Examples 1 and 3-10, where the method further comprises the pipeline creation rules indicate mappers, shufflers, and reducers to create in each of the computing systems for which the pipeline creation rules are intended. The method further comprises a distributed controller receiving a pipeline creation rule for a target computing system configures indicated mappers, shufflers and reducers in the target computing system for which the pipeline creation rule is directed. Thus, embodiments advantageously allow a distributed controller to configure pipelines comprising mappers, shufflers, and reducers based on the pipeline creation rule to optimize how mappers, shufflers, and reducers are configured across computing systems to optimize processing of the predicted data processing usage.

Example 3: The limitations of any of Examples 1, 2 and 4-10, where the method further comprises that the pipeline redistribution rules are processed by a distributed controller. The method further comprises the distributed controller receives data for a requested service. The method further comprises the distributed controller determines a pipeline redistribution rule associated with the requested service. The method further comprises the distributed controller determines a pipeline in a computing system indicated in the determined pipeline redistribution rule. The method further comprises the distributed controller forwards the received data to the determined pipeline in the computing system indicated in the determined pipeline redistribution rule. Thus, embodiments advantageously allow a distributed controller, which is typically closest to the edge computing systems, to apply the redistribution rules and forward the received data to the pipelines in the edge systems managed by the distributed controller. This reduces latency by having a distributed controller closest to the edge systems manage the distribution of data processing jobs across pipelines in the edge systems.

Example 4: The limitations of any of Examples 1-3 and 5-10, where the method further comprises that the bursting pipeline redistribution rule is processed by a distributed controller. The method further comprises the distributed controller receives data for a requested service. The method further comprises the distributed controller, determines the bursting pipeline redistribution rule associated with the requested service. The method further comprises the distributed controller determines pipelines in computing systems indicated in the bursting pipeline redistribution rule. The method further comprises the distributed controller forwards portions of the received data to the determined pipelines in the computing systems indicated in the bursting pipeline redistribution rule to process. Thus, embodiments advantageously allow a distributed controller, which is typically closest to the edge computing systems, to apply the bursting redistribution rules and forward the received data to the pipelines involved in bursting in the edge systems managed by the distributed controller. This reduces latency by having a distributed controller closest to the edge systems manage the bursting of data across pipelines in the edge systems.

Example 5: The limitations of any of Examples 1-4 and 6-10, where the method further comprises that the bursting pipeline redistribution rule indicates computing systems managed by the distributed controller processing the bursting pipeline redistribution rule. Thus, embodiments advantageously have bursting across pipelines in edge systems managed by a distributed controller to minimize latency in processing because the edge systems managed by a distributed controller are typically closest to that distributed controller.

Example 6: The limitations of any of Examples 1-5 and 7-10, where the method further comprises that the bursting pipeline redistribution rule indicates edge computing systems, to which the portions of the received data are forwarded, managed by different distributed controllers including the distributed controller processing the bursting pipeline redistribution rule. Thus, embodiments advantageously have bursting across pipelines in edge systems managed by different distributed controller to provide more opportunities for optimization across a greater number of edge systems by extending bursting across distributed controllers.

Example 7: The limitations of any of Examples 1-6 and 8-10, where the method further comprises that the bursting pipeline redistribution rule indicates a service and a delay time condition and is processed by a distributed controller to receive data for a requested service and determine whether a detected delay time, between computing systems indicated in the bursting pipeline redistribution rule indicating the requested service, satisfies the delay time condition indicated in the bursting pipeline redistribution rule. The method further comprises that the distributed controller determines pipelines in the computing systems indicated in the bursting pipeline redistribution rule in response to determining the detected delay time between the computing systems satisfies the delay time condition indicated in the bursting pipeline redistribution rule. The method further comprises that the distributed controller forward different parts of the received data to the determined pipelines in the computing systems indicated in the bursting pipeline redistribution rule to process. Thus, embodiments advantageously allow for reducing latency by requiring the detected delay time between the computing systems across which the data processing job is burst satisfy a delay time condition to ensure that bursting the data processing job across pipelines will not experience undue latency due to delay time between the computing systems.

Example 8: The limitations of any of Examples 1-7 and 9-10, where the method further comprises that the pipeline redistribution rules indicate a service and a data size condition. The method further comprises a distributed controller receives data for a requested service and determines a pipeline redistribution rule indicating the requested service and indicating a data size condition satisfied by a data size of the received data. The method further comprises the distributed controller determines a pipeline in a computing system indicated in the determined pipeline redistribution rule. The method further comprises the distributed controller forwards the received data to the determined pipeline in the computing system indicated in the determined pipeline redistribution rule. Thus, embodiments advantageously allow selection of a pipeline redistribution rule specific to the service and data size of the data to process to select a configured pipeline that has the optimal configuration to process data according to the service and data size of the data, which are often key determiners of the pipeline processing requirements.

Example 9: The limitations of any of Examples 1-8 and 10, where the method further comprises that the pipeline redistribution rules indicate a complexity. The method further comprises a distributed controller receives data for a requested processing task complexity. The method further comprises the distribute controller determines a pipeline redistribution rule indicating the requested processing task complexity. The method further comprises the distributed controller determines a pipeline in a computing system indicated in the determined pipeline redistribution rule. The method further comprises the distributed controller forwards the received data to the determined pipeline in the computing system indicated in the determined pipeline redistribution rule. Thus, embodiments advantageously allow selection of a pipeline redistribution rule specific to the complexity of the data to process to select a configured pipeline that has the optimal configuration to process data according to the complexity, which is often a key determiner of the pipeline processing requirements.

Example 10: The limitations of any of Examples 1-9, where the method further comprises that pipeline redistribution rules indicate a service, a complexity, and a data size condition. The method further comprises a distributed controller receives data for a requested service, requested processing task complexity, and requested data size. The method further comprises the distributed controller determines a pipeline redistribution rule indicating the requested service, the requested processing task complexity, and a data size condition satisfied by the requested data size. The method further comprises the distributed controller determines a pipeline in a computing system indicated in the determined pipeline redistribution rule. The method further comprises the distributed controller forwards the received data to the determined pipeline in the computing system indicated in the determined pipeline redistribution rule. Thus, embodiments advantageously allow selection of a pipeline redistribution rule specific to the service, complexity, and data size of the data to process to select a configured pipeline that has the optimal configuration to process data according to the service, complexity, and data size, which are often key determiners of the pipeline processing requirements.

Example 11 is an apparatus comprising means to perform a method of any of the Examples 1-10.

Example 12 is a machine-readable storage including machine-readable instructions, when executed, to implement a method or realize an apparatus of any of the Examples 1-10.

Example 13: A system comprising one or more processor and one or more computer-readable storage media collectively storing program instructions which, when executed by the processor, are configured to cause the processor to perform a method according to any of Examples 1-10.

Example 14: A computer program product comprising one or more computer readable storage media, and program instructions collectively stored on the one or more computer readable storage media, the program instructions comprising instructions configured to cause one or more processors to perform a method according to any one of Examples 1-10.

Described embodiments provide improvements to computer technology for configuring pipelines and creating redistribution rules for assigning pipelines to data processing tasks that utilizes bursting to have portions of a job processed by pipelines on different edge systems. Described embodiments further provide techniques to continuously identify optimal data pipeline configurations, optimally service current traffic needs, and propagate future data processing jobs to the edge systems. Described embodiments infer opportunities for optimization based on assessing of Quality of Service (QoS) for the services offered at the edge systems and predicting data processing performance. Data pipeline redistribution plans may be inferred for identified opportunities to allow for bursting to pipelines across edge systems, and to infer reactive and proactive data pipeline redistribution rules that are propagated to distributed controllers to manage the routing of data processing tasks to pipelines on one or more edge systems.

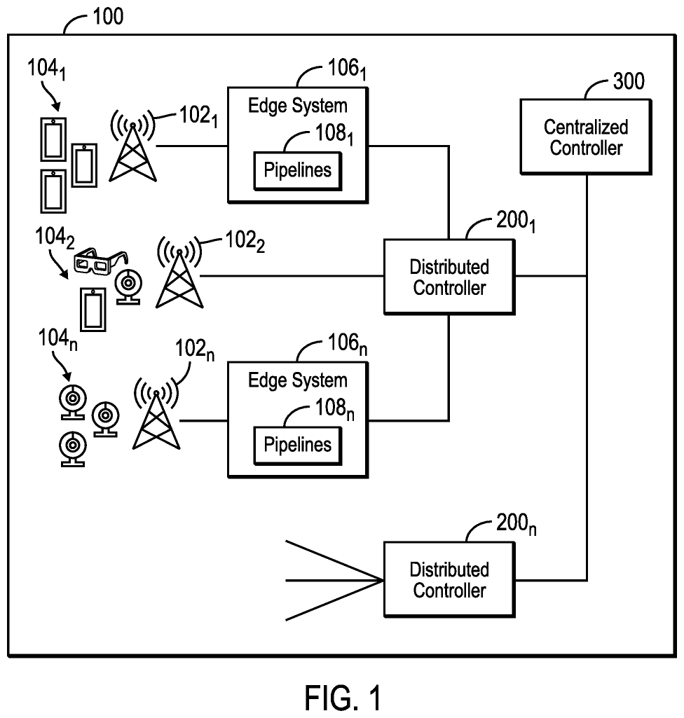

FIG. 1 illustrates an embodiment of a cellular network 100 in which embodiments are implemented, such as, but not limited to, a 4G, 5G or 6G network. The cellular network 100 includes a plurality of base stations 102₁, 102₂ . . . 102ₙ, also referred to as static cellular stations or terrestrial stations. The data processing jobs from user equipment 104₁, 104₂ . . . 104ₙ, are received at the base stations 102₁, 102₂ . . . 102ₙ. The jobs from the user equipment 104₁, 104₂ . . . 104ₙ may be processed in applications at edge systems 106₁ . . . 106ₙ, which may comprise multiaccess-edge computing (MEC) servers. The processing of jobs from the base stations 102₁, 102₂ . . . 102ₙ are managed by a distributed controller 200₁. The distributed controller 200₁ routes data processing jobs from user devices 104₁, 104₂ . . . 104ₙ received at the managed base stations 102₁, 102₂ . . . 102ₙ to pipelines 108₁ . . . 108ₙ configured in the edge systems 106₁ . . . 106ₙ managed by the distributed controller 200₁. Additional distributed controllers 200n may similarly manage data processing tasks received at further base stations at further edge systems.

The distributed controllers 200₁ . . . 200ₙ may gather performance and task processing information, including information on attached user equipment 104ᵢ, services in use, etc., and send to a centralized controller 300 that determines how to configure pipelines 108ᵢ in the edge systems 106ᵢ and how to route data processing jobs from base stations 102ᵢ to edge systems 106ᵢ, including allowing bursting of data processing jobs to pipelines in different edge systems.

The edge systems 106ᵢ may implement applications and the pipelines 108ᵢ process data processing jobs using different applications implemented in the edge systems 106ᵢ, such as applications for different types of jobs, e.g., gaming, autonomous driving, etc.

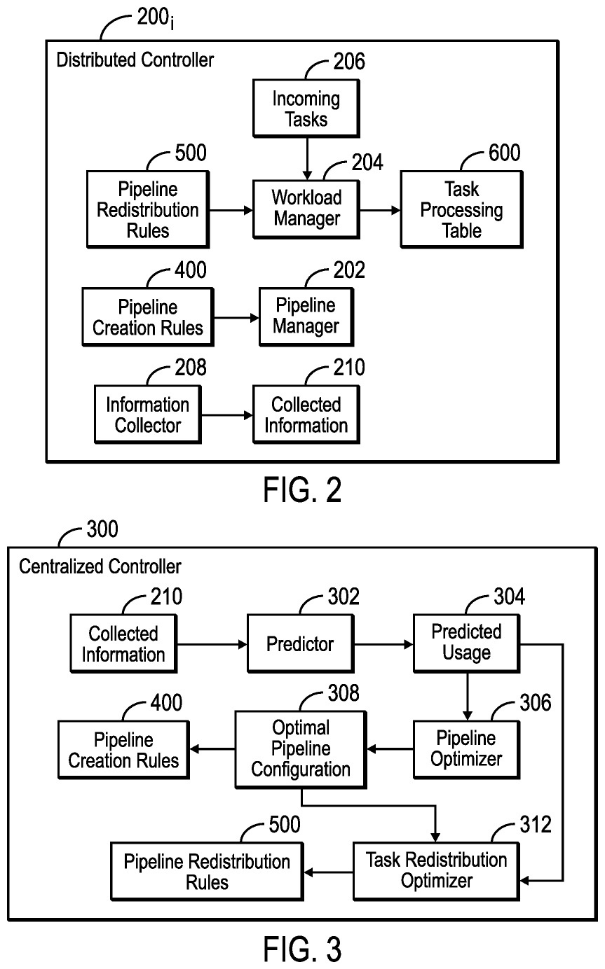

FIG. 2 illustrates an embodiment of a distributed controller 200ᵢ including a pipeline manager 202 that receives pipeline creation rules 400 to configure data processing pipelines 108ᵢ in the edge systems 106ᵢ managed by the distributed controller 200ᵢ. A workload manager 204 processes incoming data processing tasks 206 using pipeline redistribution rules 500 to select one or more pipelines at which to process the data processing task and build a task processing table 600 indicating edge systems and pipelines to which to distribute the received incoming data processing tasks 206. The distributed controller 200ᵢ further includes an information collector 208 to gather collected information 210, on data processing performance, attached users, services, and Quality of Service (QoS) fulfillments in the processing, to forward to the centralized controller 300.

FIG. 3 illustrates an embodiment of the centralized controller 300 as including a predictor 302 that receives collection information 210 as input and outputs a predicted usage 304 or future predicted data processing usage. The predicted usage 304 is inputted to a pipeline optimizer 306 to output an optimal pipeline configuration 308. From the optimal pipeline configuration 308, pipeline creation rules 400 are generated. The centralized controller 300 further includes a task redistribution optimizer 312 that receives the predicted usage 304 and the optimal pipeline configuration 308 and generates optimal pipeline redistribution rules 500 to distribute received processing tasks from the base stations 102₁ . . . 102ₙ to configured pipelines 108i at the edge systems 106ᵢ, such that data processing jobs may be burst across pipelines in multiple edge systems to further optimize performance.

Generally, program modules, such as the program components 108ᵢ, 202, 204, 208, 302, 306, 312, among others, may comprise routines, programs, objects, components, logic, data structures, and so on that perform particular tasks or implement particular abstract data types.

The programs 108ᵢ, 202, 204, 208, 302, 306, 312, among others, may comprise program code loaded into memory and executed by a processor. Alternatively, some or all of the functions of these components may be implemented in hardware devices, such as in Application Specific Integrated Circuits (ASICs), Field Programmable Gate Arrays (FPGAs) or executed by separate dedicated processors.

The functions described as performed by the program components 108ᵢ, 204, 202, 208, 302, 306, 312, among others, may be implemented as program code in fewer program modules than shown or implemented as program code throughout a greater number of program modules than shown.

The computing components 106ᵢ, 200ᵢ, and 300 may comprise server class computing devices, or other suitable computing devices.

In described embodiments, operations of 108ᵢ, 202, 204, 208, 302, 306, 312, described as performed in components 106ᵢ, 200ᵢ, and 300, may be performed in other components or distributed among components. For instance, the user equipment may comprise other types of computational devices providing data to be processed than user equipment communicating data with cellular base stations.

In FIGS. 2 and 3 arrows are shown between components in the distributed controller 200ᵢ and the centralized controller 300. These arrows represent information flow to and from the program components.

Certain of the program components, such as 202, 204, 208, 302, 306, 312, may use machine learning and deep learning algorithms, such as decision tree learning, association rule learning, neural network, inductive programming logic, support vector machines, Bayesian network, Recurrent Neural Networks (RNN), Feedforward Neural Networks, Convolutional Neural Networks (CNN), Deep Convolutional Neural Networks (DCNNs), Generative Adversarial Network (GAN), etc. For artificial neural network program implementations, the neural network may be trained using backward propagation to adjust weights and biases at nodes in a hidden layer to produce their output based on the received inputs. In backward propagation used to train a neural network machine learning module, biases at nodes in the hidden layer are adjusted accordingly to produce the output having specified confidence levels based on the input parameters. The machine learning models 202, 204, 208, 302, 306, 312 may be trained to produce their output for product information and product recommendations, respectively, based on the inputs. Backward propagation may comprise an algorithm for supervised learning of artificial neural networks using gradient descent. Given an artificial neural network and an error function, the method may use gradient descent to find the parameters (coefficients) for the nodes in a neural network or function that minimizes a cost function measuring the difference or error between actual and predicted values for different parameters. The parameters are continually adjusted during gradient descent to minimize the error.

In an alternative embodiment, the components 202, 204, 208, 302, 306, 312, may be implemented not as a machine learning model but implemented using a rules-based system to determine the outputs from the inputs. The components 202, 204, 208, 302, 306, 312 may further be implemented using an unsupervised machine learning module, or machine learning implemented in methods other than neural networks, such as multivariable linear regression models.

Components implemented as a machine learning model may be implemented in programs in memory or in a hardware accelerator or an inference engine.

Described embodiments concern providing pipeline processing at edge systems in a cellular network to service data processing transmissions through base stations. In alternative embodiments, the edge systems may comprise any type of computing system servicing user requests in environments other than cellular networks and in other types of data processing environments. In yet further embodiments, the edge system may comprise other types of systems.

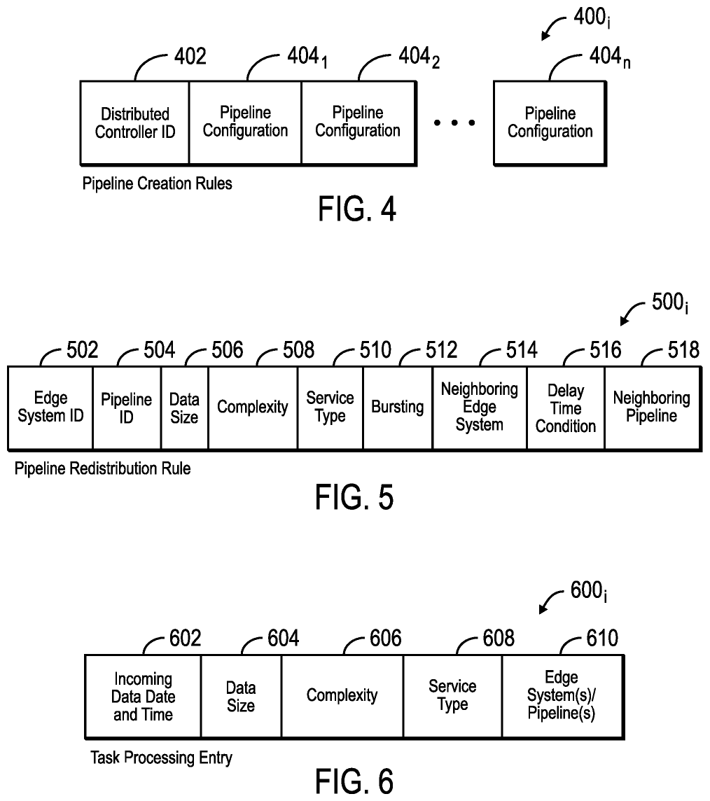

FIG. 4 illustrates an embodiment of an instance of pipeline creation rules 400ᵢ for a distributed controller 200ᵢ and includes: a distributed controller 402 indicating a distributed controller 200ᵢ to receive the pipeline creation rules 400ᵢ, and a plurality of pipeline configurations 404₁ . . . 404ₙ. Each pipeline configuration 404ᵢ indicates an edge system 106ᵢ on which to create the pipeline 108ᵢ and pipeline resources to create for the pipeline. For instance, for a MapReduce pipeline, a pipeline configuration 404ᵢ may indicate a number of mappers, shufflers, and reducers to create. Each mapper applies a mapping function to the input data, a shuffler redistributes data based on the output to the reducers, and a reducer processes each group of output data to a single key. MapReduce allows for the distributed processing of the map and reduction operations. Other pipeline technology, other than MapReduce, may be used to implement the pipelines 108ᵢ.

FIG. 5 illustrates an embodiment of a pipeline redistribution rule 500ᵢ sent to a distributed controller 200ᵢ, including: an edge system identifier (ID) 502 identifying the edge system 106ᵢ in which the pipeline is implemented; a pipeline ID 504 identifying the pipeline in the edge system 502; a data size condition 506 indicating a data size condition to which the rule 500ᵢ applies, e.g., greater than, less than or within a range; a complexity 508 of the processing request to which the rule 500ᵢ applies, such as simple or complex; a service type 510 indicating a service to which the rule 500i applies, such as Ultra Reliable Low latency Communications (URLLC), enhanced Mobile Broadband (eMBB), massive Machine type communications (mMTC), etc.; and a bursting flag 512 indicating whether bursting applies to burst the data processing task on pipelines across edge systems. If the bursting flag 512 indicates bursting, then the optional bursting fields include: neighboring edge system 514 comprising an edge system 106ⱼ to which a portion of the data processing job may be distributed; a delay time condition 516 indicating a delay timing condition to transmit data between the neighboring edge system 514 and the primary edge system 502; and a neighboring pipeline 518 in the neighboring edge system 514 to which the job is distributed.

In one embodiment, the neighboring edge system 514 is managed by the same distributed controller 200ᵢ managing the primary edge system 502. In further embodiments, the neighboring edge system 514 may be managed by a different distributed controller 200ⱼ than the distributed controller 200ᵢ managing the primary edge system 502.

FIG. 6 illustrates an embodiment of a task processing entry 600ᵢ in the task processing table 600 having information on pipeline resources assigned to a task, including: incoming data date and time 602 to identify the data processing job; data size 604 to process; complexity 606 of data to process; service type 608; and one or more edge system(s)/pipeline(s) 610 to process the incoming data 602. Multiple pipelines on different edge systems are specified if there is bursting. The distributed controller 200ᵢ uses the task processing entry 600ᵢ information to identify a job and indicate the pipeline to which the job is routed.

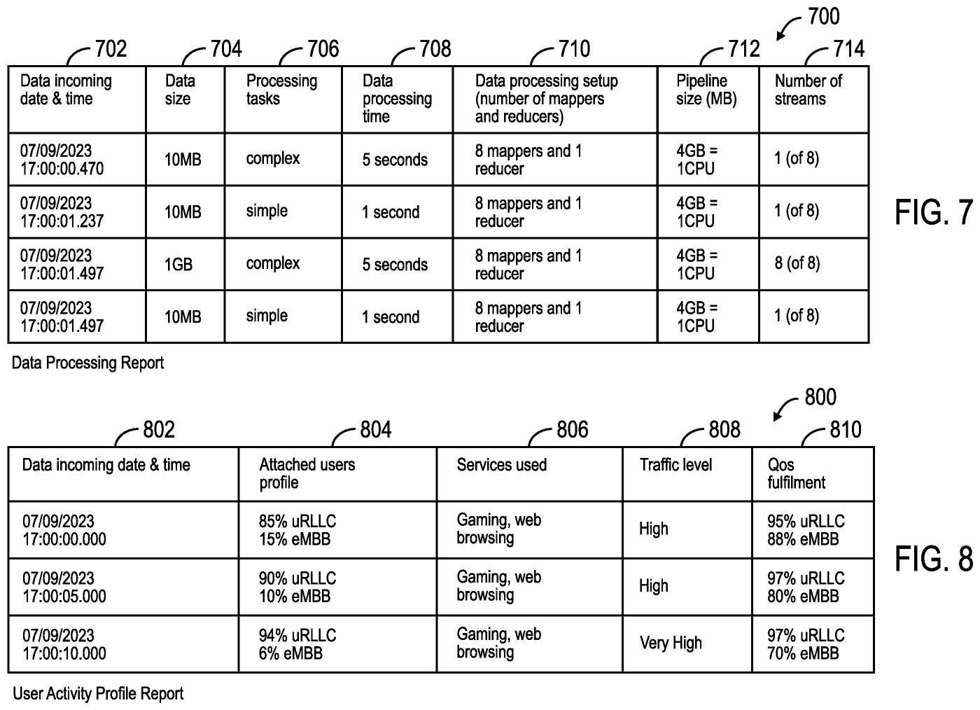

FIG. 7 illustrates an example of a data processing report 700 that may comprise part of the collected information 210 that the information collector 208 on a distributed controller 200ᵢ gathers to forward to the centralized controller 300, and includes: the data incoming date and time 702 identifying the data processing job; data size 704; processing complexity 704; data processing time 706; resources involved 708 in processing; pipeline size 710; and number of streams 712 used by the pipeline in processing.

FIG. 8 illustrates an example of a user activity profile report 800 that may comprise part of the collected information 210 that the information collector 208 on a distributed controller 200ᵢ gathers to forward to the centralized controller 300, and includes: the data incoming date and time 802 identifying the data processing job; attached users' profile 804, such as service type of URLLC, eMBB, mMTC, etc.; services used 808, such as gaming, web browsing, autonomous driving, etc.; traffic level; and QoS fulfillment 810 for the different user profiles.

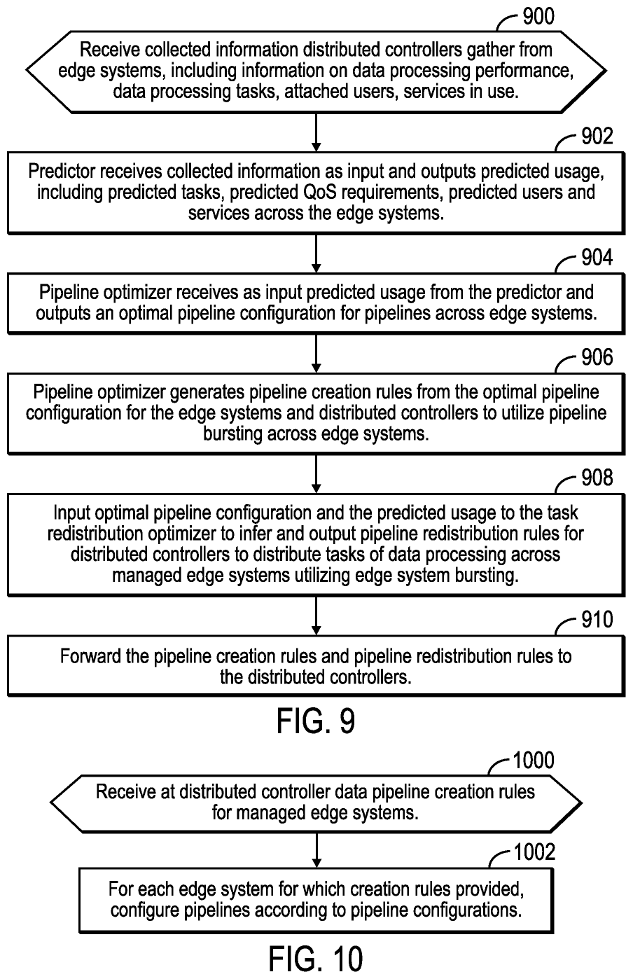

FIG. 9 illustrates an embodiment of operations performed at the central computer 300 to process received collected information 210 gathered by the distributed controllers 200ᵢ, including information on data processing performance, data processing tasks, attached users, services in use, e.g., FIGS. 7 and 8. Upon the predictor 302 receiving (at block 900) the collected information 210, the collected information 210 is inputted (at block 902) to the predictor 302 to output predicted usage 304, including predicted tasks, predicted QoS requirements, predicted users and services across the edge systems. The pipeline optimizer 306 receives (at block 904) as input the predicted usage 304 and outputs an optimal pipeline configuration 308 for pipelines 108ᵢ across edge systems 106ᵢ across distributed controllers 200ᵢ to handle the predicted usage 304 The pipeline optimizer 306 or another component may generate (at block 906) pipeline creation rules 400 for the edge systems 106ᵢ and distributed controllers 200ᵢ from the optimal pipeline configuration 308 that utilize pipeline bursting across edge systems 106ᵢ. For instance, the pipeline optimizer 306 or other component may use inference to infer the creation rules 400ᵢ from the optimal pipeline configuration 308. The optimal pipeline configuration 308 and the predicted usage 304 are inputted (at block 908) to the task redistribution optimizer 312 to infer and output pipeline redistribution rules 500ᵢ for distributed controllers to distribute tasks of data processing across managed edge systems 106ᵢ utilizing edge system bursting. The pipeline creation rules 400ᵢ and pipeline redistribution rules 500ᵢ are forwarded (at block 910) to the distributed controllers 200ᵢ.

With the embodiment of FIG. 9, the central controller 300 predicts future usage and an optimal pipeline configuration across edge systems to distribute processing of a data processing task across pipelines in different edge systems. The optimal configuration and predicted usage are further used to generate pipeline redistribution rules 500ᵢ to distribute tasks according to task attributes such as data size, complexity, and service across the edge systems 106ᵢ to optimize task processing in pipelines with edge system and allow for bursting to pipelines in different edge systems to minimize processing latency.

FIG. 10 illustrates an embodiment of operations performed by the pipeline manager 202 in a distributed controller 200ᵢ to configure pipelines 108ᵢ in edge systems 106ᵢ managed by the distributed controller 200ᵢ according to the received pipeline creation rules 400ᵢ. Upon receiving (at block 1000) pipeline creation rules 400ᵢ for edge systems 106ᵢ managed by the distributed controller 200ᵢ, the pipeline manager 202 configures (at block 1002) pipelines according to pipeline configurations 404ᵢ in the received pipeline creation rules 400ᵢ for the distribute controller 200ᵢ. In certain MapReduce implementations, the configured pipeline resources in a pipeline may include a number of mappers, shifters, and reducers.

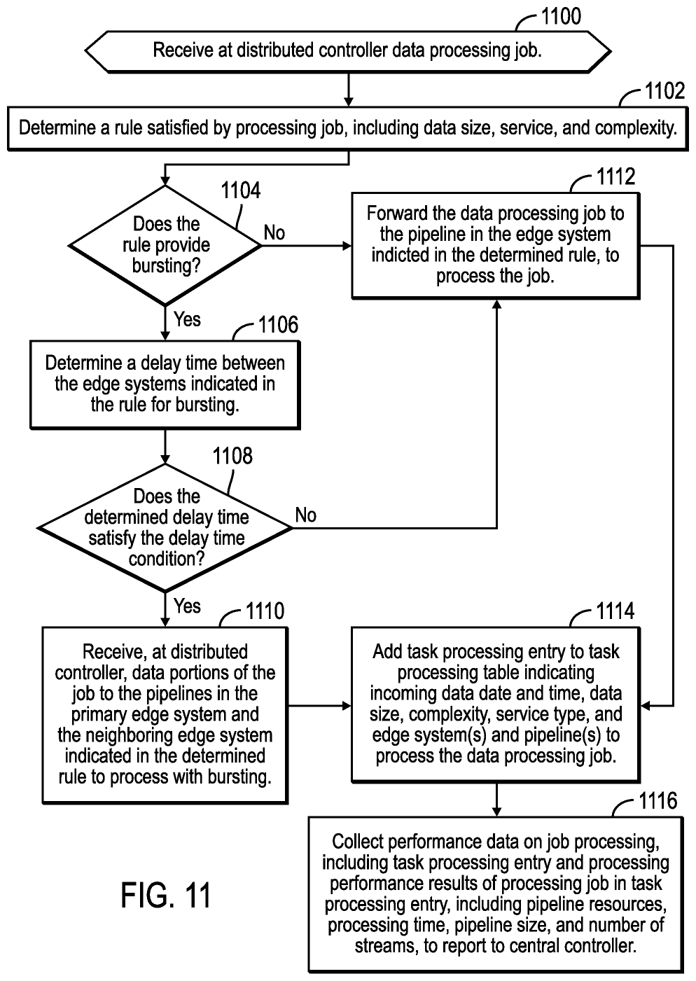

FIG. 11 illustrates an embodiment of operations performed by a workload manager 204 within a distributed controller to assign pipelines to process a data processing task. Upon receiving (at block 1100) a data processing job, the workload manager 204 determines (at block 1102) a pipeline redistribution rule 500ᵢ satisfied by the processing job, including satisfying the data size 506, complexity 508, and service type 510 criteria. If (at block 1104) the determined rule 500ᵢ provides for bursting, as indicated in field 512, the workload manager 204 determines (at block 1106) a delay time between the edge systems 502 and 514 indicated in the rule 500ᵢ. If (at block 1108) the determined delay time satisfies a delay time condition 516, then the workload manager 204 distributes (at block 1110) portions of the job to the pipelines 504, 518 in the primary edge system 502 and the neighboring edge system 514, respectively, indicated in the determined rule 500ᵢ, to process with bursting. If (at block 1104) the determined pipeline redistribution rule 500ᵢ does not provide for bursting or if (at block 1108) the determined delay time does not satisfy the delay time condition 516, then the data processing job is forwarded (at block 1112) to the pipeline 504 in edge system 502, indicted in the determined rule 500ᵢ, to process the job without bursting.

From block 1110 or 1112, the workload manager 204 adds (at block 1114) a task processing entry 600ᵢ to the task processing table 600 indicating incoming data date and time, data size, complexity, service type, and edge system(s) and pipeline(s) to process the data processing job in fields 602, 604, 606, 608, and 610, respectively. In this way, task processing table entries 600ᵢ record how tasks are processed in the system. After the job is processed, the workload manager 204 may collect (at block 1116) performance data on the job processing, including task processing entry 600ᵢ information and processing performance results of processing job in task processing entry 600i, including processing time 708, pipeline resources used 710, pipeline size 712, and number of streams 714, to report to the central controller 300.

With the embodiment of FIG. 11, the workload manager 204 applies the provided pipeline redistribution rule 500ᵢ that satisfies the conditions of the data. If the determined rule provides for bursting, then portions of the job are distributed to pipelines on different neighboring edge systems 106ᵢ, 106ⱼ to provide for further parallelization of the processing across edge systems to improve processing performance, and optimize pipeline allocation.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

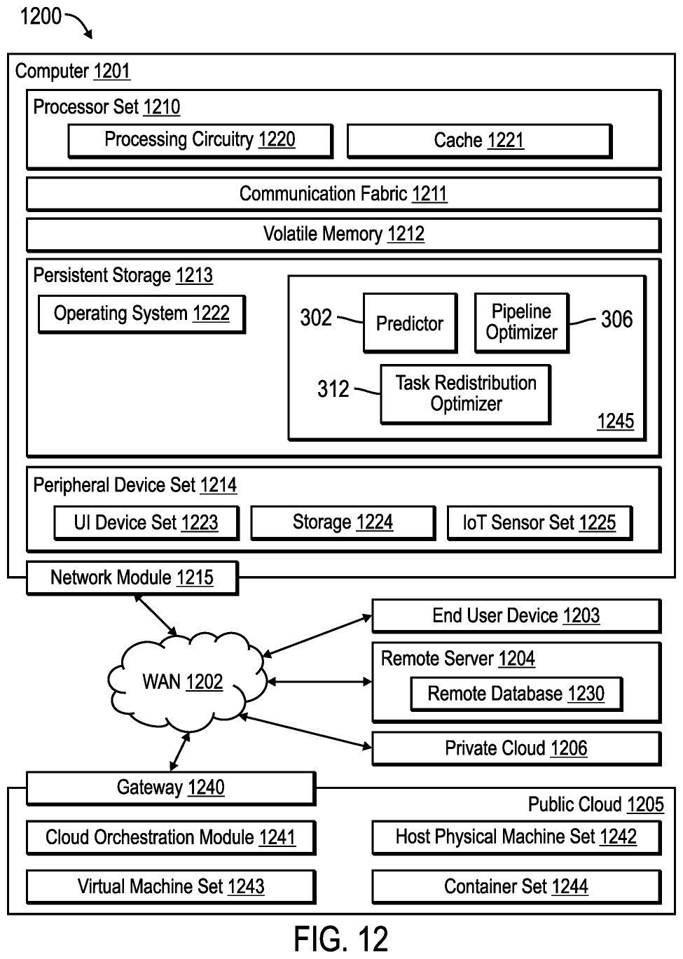

With respect to FIG. 12, computing environment 1200 contains an example of an environment for the execution of at least some of the computer code involved in performing the inventive methods, such as the predictor 302, pipeline optimizer 306, and task redistribution optimizer 312 to generate pipeline creation rules 400 and pipeline redistribution rules 500 in block 1245. In addition to block 1245, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1245, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible. Computer 1201 may be located in a cloud, even though it is not shown in a cloud in FIG. 12. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer-readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1245 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface-type operating systems that employ a kernel. The code included in block 1245 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. IoT sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer-readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on. In further embodiments, the EUDs 1203 may comprise the user equipment 104₁ . . . 104ₙ providing data processing jobs to process.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204. The remote server 1204 may comprise the edge systems 106₁ . . . 106ₙ and distributed controllers 200₁ . . . 200ₙ described above.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

CLOUD COMPUTING SERVICES AND/OR MICROSERVICES (not separately shown in FIG. 12): private and public clouds 1206 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i, j, and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for managing pipeline processing in computing systems coupled to distributed controllers, the computer program product comprises a computer readable storage medium having program instructions embodied therewith that when executed cause operations, the operations comprising:
receiving, from the distributed controllers, information on processing performance and data processing tasks, for user equipment, at the computing systems;
predicting, from the received information, data processing usage at the computing systems;
generating pipeline creation rules to allocate pipeline computing resources to the computing systems to optimize for the predicted data processing usage;
generating pipeline redistribution rules to direct traffic for the user equipment to pipelines within the computing systems allocated according to the pipeline creation rules, wherein the pipeline redistribution rules include a bursting pipeline redistribution rule indicating to distribute received data to pipelines in multiple computing systems to process; and
transmitting the pipeline creation rules and the pipeline redistribution rules, including bursting redistribution rules, to the distributed controllers to implement the pipeline creation rules and the pipeline redistribution rules.

2. The computer program product of claim 1, wherein the pipeline creation rules indicate mappers, shufflers, and reducers to create in each of the computing systems for which the pipeline creation rules are intended, wherein a distributed controller receiving a pipeline creation rule for a target computing system configures indicated mappers, shufflers and reducers in the target computing system for which the pipeline creation rule is directed.

3. The computer program product of claim 1, wherein pipeline redistribution rules are processed by a distributed controller to perform:
receiving data for a requested service;
determining a pipeline redistribution rule associated with the requested service;
determining a pipeline in a computing system indicated in the determined pipeline redistribution rule; and
forwarding the received data to the determined pipeline in the computing system indicated in the determined pipeline redistribution rule.

4. The computer program product of claim 1, wherein the bursting pipeline redistribution rule is processed by a distributed controller to perform:
receiving data for a requested service;
determining the bursting pipeline redistribution rule associated with the requested service;
determining pipelines in computing systems indicated in the bursting pipeline redistribution rule; and
forwarding portions of the received data to the determined pipelines in the computing systems indicated in the bursting pipeline redistribution rule to process.

5. The computer program product of claim 4, wherein the bursting pipeline redistribution rule indicates computing systems managed by the distributed controller processing the bursting pipeline redistribution rule.

6. The computer program product of claim 4, wherein the bursting pipeline redistribution rule indicates edge computing systems, to which the portions of the received data are forwarded, managed by different distributed controllers including the distributed controller processing the bursting pipeline redistribution rule.

7. The computer program product of claim 1, wherein the bursting pipeline redistribution rule indicates a service and a delay time condition and is processed by a distributed controller to perform:
receiving data for a requested service;
determining whether a detected delay time, between computing systems indicated in the bursting pipeline redistribution rule indicating the requested service, satisfies the delay time condition indicated in the bursting pipeline redistribution rule;
determining pipelines in the computing systems indicated in the bursting pipeline redistribution rule in response to determining the detected delay time between the computing systems satisfies the delay time condition indicated in the bursting pipeline redistribution rule; and
forwarding different parts of the received data to the determined pipelines in the computing systems indicated in the bursting pipeline redistribution rule to process.

8. The computer program product of claim 1, wherein pipeline redistribution rules indicate a service and a data size condition and are processed by a distributed controller to perform:
receiving data for a requested service;
determining a pipeline redistribution rule indicating the requested service and indicating a data size condition satisfied by a data size of the received data;
determining a pipeline in a computing system indicated in the determined pipeline redistribution rule; and
forwarding the received data to the determined pipeline in the computing system indicated in the determined pipeline redistribution rule.

9. The computer program product of claim 1, wherein pipeline redistribution rules indicate a complexity, and are processed by a distributed controller to perform:
receiving data for a requested processing task complexity;
determining a pipeline redistribution rule indicating the requested processing task complexity;
determining a pipeline in a computing system indicated in the determined pipeline redistribution rule; and
forwarding the received data to the determined pipeline in the computing system indicated in the determined pipeline redistribution rule.

10. The computer program product of claim 1, wherein pipeline redistribution rules indicate a service, a complexity, and a data size condition, and are processed by a distributed controller to perform:
receiving data for a requested service, requested processing task complexity, and requested data size;
determining a pipeline redistribution rule indicating the requested service, the requested processing task complexity, and a data size condition satisfied by the requested data size;
determining a pipeline in a computing system indicated in the determined pipeline redistribution rule; and
forwarding the received data to the determined pipeline in the computing system indicated in the determined pipeline redistribution rule.

11. A system for managing pipeline processing in computing systems coupled to distributed controllers, comprising:
a processor; and
a computer readable storage medium having program instructions embodied therewith that when executed by the processor cause operations, the operations
receiving, from the distributed controllers, information on processing performance and data processing tasks, for user equipment, at the computing systems;
predicting, from the received information, data processing usage at the computing systems;
generating pipeline creation rules to allocate pipeline computing resources to the computing systems to optimize for the predicted data processing usage;
generating pipeline redistribution rules to direct traffic for the user equipment to pipelines within the computing systems allocated according to the pipeline creation rules, wherein the pipeline redistribution rules include a bursting pipeline redistribution rule indicating to distribute received data to pipelines in multiple computing systems to process; and
transmitting the pipeline creation rules and the pipeline redistribution rules, including bursting redistribution rules, to the distributed controllers to implement the pipeline creation rules and the pipeline redistribution rules.

12. The system of claim 11, wherein pipeline redistribution rules are processed by a distributed controller to perform:
receiving data for a requested service;
determining a pipeline redistribution rule associated with the requested service;
determining a pipeline in a computing system indicated in the determined pipeline redistribution rule; and
forwarding the received data to the determined pipeline in the computing system indicated in the determined pipeline redistribution rule.

13. The system of claim 11, wherein the bursting pipeline redistribution rule is processed by a distributed controller to perform:
receiving data for a requested service;
determining the bursting pipeline redistribution rule associated with the requested service;
determining pipelines in computing systems indicated in the bursting pipeline redistribution rule; and
forwarding portions of the received data to the determined pipelines in the computing systems indicated in the bursting pipeline redistribution rule to process.

14. The system of claim 11, wherein the bursting pipeline redistribution rule indicates a service and a delay time condition and is processed by a distributed controller to perform:
receiving data for a requested service;
determining whether a detected delay time, between computing systems indicated in the bursting pipeline redistribution rule indicating the requested service, satisfies the delay time condition indicated in the bursting pipeline redistribution rule;
determining pipelines in the computing systems indicated in the bursting pipeline redistribution rule in response to determining the detected delay time between the computing systems satisfies the delay time condition indicated in the bursting pipeline redistribution rule; and
forwarding different parts of the received data to the determined pipelines in the computing systems indicated in the bursting pipeline redistribution rule to process.

15. The system of claim 11, wherein pipeline redistribution rules indicate a service, a complexity, and a data size condition, and are processed by a distributed controller to perform:
receiving data for a requested service, requested processing task complexity, and requested data size;
determining a pipeline redistribution rule indicating the requested service, the requested processing task complexity, and a data size condition satisfied by the requested data size;
determining a pipeline in a computing system indicated in the determined pipeline redistribution rule; and
forwarding the received data to the determined pipeline in the computing system indicated in the determined pipeline redistribution rule.

16. A method for managing pipeline processing in computing systems coupled to distributed controllers, comprising:
receiving, from the distributed controllers, information on processing performance and data processing tasks, for user equipment, at the computing systems;
predicting, from the received information, data processing usage at the computing systems;
generating pipeline creation rules to allocate pipeline computing resources to the computing systems to optimize for the predicted data processing usage;
generating pipeline redistribution rules to direct traffic for the user equipment to pipelines within the computing systems allocated according to the pipeline creation rules, wherein the pipeline redistribution rules include a bursting pipeline redistribution rule indicating to distribute received data to pipelines in multiple computing systems to process; and
transmitting the pipeline creation rules and the pipeline redistribution rules, including bursting redistribution rules, to the distributed controllers to implement the pipeline creation rules and the pipeline redistribution rules.

17. The method of claim 16, wherein pipeline redistribution rules are processed by a distributed controller to perform:
receiving data for a requested service;
determining a pipeline redistribution rule associated with the requested service;
determining a pipeline in a computing system indicated in the determined pipeline redistribution rule; and
forwarding the received data to the determined pipeline in the computing system indicated in the determined pipeline redistribution rule.

18. The method of claim 16, wherein the bursting pipeline redistribution rule is processed by a distributed controller to perform:
receiving data for a requested service;
determining the bursting pipeline redistribution rule associated with the requested service;
determining pipelines in computing systems indicated in the bursting pipeline redistribution rule; and
forwarding portions of the received data to the determined pipelines in the computing systems indicated in the bursting pipeline redistribution rule to process.

19. The method of claim 16, wherein the bursting pipeline redistribution rule indicates a service and a delay time condition and is processed by a distributed controller to perform:
receiving data for a requested service;
determining whether a detected delay time, between computing systems indicated in the bursting pipeline redistribution rule indicating the requested service, satisfies the delay time condition indicated in the bursting pipeline redistribution rule;
determining pipelines in the computing systems indicated in the bursting pipeline redistribution rule in response to determining the detected delay time between the computing systems satisfies the delay time condition indicated in the bursting pipeline redistribution rule; and
forwarding different parts of the received data to the determined pipelines in the computing systems indicated in the bursting pipeline redistribution rule to process.

20. The method of claim 16, wherein pipeline redistribution rules indicate a service, a complexity, and a data size condition, and are processed by a distributed controller to perform:
receiving data for a requested service, requested processing task complexity, and requested data size;
determining a pipeline redistribution rule indicating the requested service, the requested processing task complexity, and a data size condition satisfied by the requested data size;
determining a pipeline in a computing system indicated in the determined pipeline redistribution rule; and
forwarding the received data to the determined pipeline in the computing system indicated in the determined pipeline redistribution rule.
